(19) United States
(12) Patent Application Publication
(10) Pub. No.: US 2006/0036004 A1
(43) Pub. Date: Feb. 16, 2006

(54) Cellulose reinforced composite composition

(75) Inventors: Dong Yang Wu, Wheelers Hill (AU); Matthew Partlett, Beaumaris (AU); Stuart Bateman, Northcote (AU)

Correspondence Address: PILLSBURY WINTHROP SHAW PITTMAN, LLP, P.O. BOX 10500, MCLEAN, VA, 22102, US

(73) Assignee: Commonwealth Scientific and Industrial Research Organisation, Campbell (AU)

(21) Appl. No.: 11/197,496

(22) Filed: Aug. 5, 2005

Related U.S. Application Data
(63) Continuation of application No. 10/355,252, filed on Jan. 31, 2003, now abandoned.
Application No. 10/355,252 is a continuation-in-part of application No. PCT/AU01/00936, filed on Jul. 31, 2001.

(30) Foreign Application Priority Data
Jul. 31, 2000 (AU) PQ 9098

(51) Int. Cl. B29C 47/00

(52) U.S. Cl. 524/13

(57) ABSTRACT

A composite comprising a thermoplastic matrix, a cellulosic reinforcement phase and a coupling agent for improving the interaction between the thermoplastic matrix and cellulosic phase where the coupling agent is selected from compounds comprising one or more reactive nitrogen groups.

### CROSS REFERENCE TO RELATED APPLICATIONS

This application is a Continuation of U.S. application Ser. No. 10/355,252, filed Jan. 31, 2003, which is a Continuation-in-Part of PCT/AU01/00936, filed Jul. 31, 2001, published on Feb. 7, 2002 under WO 02/10272, which claims priority to Australian Patent Application PQ 9098, filed Jul. 31, 2000, the contents of all of which are incorporated herein by reference in their entirities.

### BACKGROUND

The claimed inventions relate to composite compositions containing cellulose-based reinforcements and to methods of forming composites.

Conventional wood composites such as plywood or fiberboard are composed of wood fibers and thermoset polymers such as phenolformaldehyde, resorcinol-formaldehyde, melamine-formaldehyde, urea-formaldehyde, urea-furfural and condensed furfuryl alcohol resin and organic polyisocyanate. These composite materials tend to suffer from low moisture resistance due to the hydrophilic nature of the wood, emit hazardous volatile organic compounds both during manufacturing process and under service conditions, and are unable to be recycled due to the use of the thermoset matrix resin.

The above-described problems can be overcome to a large extent by the use of thermoplastic instead of the thermoset matrix resins. However, there is a major potential drawback with the use of wood/cellulose components in thermoplastics due to the polarity difference between the hydrophilic wood/cellulose component and the hydrophobic thermoplastic matrix resin. Because of this incompatibility between the wood/cellulose-matrix system, the wood/cellulose reinforcements do not disperse well in the polymer matrix, and cannot perform as an efficient reinforcing material. Insufficient dispersion and weak interactions at the reinforcement-matrix interface lead to inferior mechanical properties of the final wood-plastic composite products, which limits their applications as a replacement for wood and thermoset resin based chipboards (particle boards, medium density fiber boards (MDF), etc).

Several approaches have been proposed to improve the compatibility and adhesion between the wood/cellulose component and the thermoplastic matrix. The emphasis has been placed on improving the interfacial adhesion between the wood/cellulose and the polymer components. Changes in the type of polymer used can provide improved interaction with cellulose components. For example thermoplastics such as maleic anhydride modified polyethylene, polypropylene, and styrene-butadiene-styrene; and ionomer modified polyethylene and low molecular weight polypropylene have been used

There is therefore a need in the industry for a composite material that may use relatively low cost cellulosic components and thermoplastics but provides good mechanical properties.

### SUMMARY

Claimed inventions provide composites including a thermoplastic resin, cellulosic reinforcement and one or more coupling agents selected from compounds comprising one or more reactive nitrogen groups and mixtures of said compounds. A suitable radical initiator may also be optionally used in combination with the coupling agent(s).

The coupling agent may be applied to the cellulose reinforcement prior to composite formation or may be incorporated into the matrix. Alternatively the coupling agent may be added during mixing of the composite components and/or during formation of the composite.

The matrix resins used may be any virgin or recycled thermoplastics, which have a melt temperature of less than the char temperature of the cellulose reinforcement materials. Preferably, the thermoplastic matrices are chosen from the group consisting of polyolefins, polyvinylchloride (PVC), polystyrene (PS), Polyethylene terephthalate (PET), High Impact Polystyrene (HIPS), Acrylonitrile-Butadiene-Styrene (ABS), nylon 6 individually or as a mixture of any combination. The preferred polyolefin for use in the compositions according to this invention are polymers containing at least 60% and preferably 90% monomer units derived from unsubstituted olefins which contain from 2 to 6 carbon atoms. These include, but are not limited to, high density polyethylene, low density polyethylene, medium density polyethylene, linear low density polyethylene, polypropylene, copolymers of ethylene with propylene, poly-1-butene, poly-4-methyl-1-pentene, copolymers of ethylene with propylene, ethylene-vinyl acetate copolymers and ethylene-vinyl chloride copolymers.

ABS used in the invention may be virgin or recycled ABS. Recycled ABS may be derived from any available sources such as automotive components, computer and printer cases, and printer cartridges etc.

The thermoplastic may be added as powder, granule, or flake. The type and amount of the thermoplastic component within the preferred wood/plastic composites will vary depending on the particular application requirements.

The thermoplastic matrix may contain various additives such as stabilizers, lubricants, antioxidants, impact modifiers, pigments, foaming agents, fire retardants and the like. These additives are preferably present in a proportion of less than 20% and more preferably less than 10%, by weight of the matrix. Inorganic fillers/fibers such as calcium carbonate, clay, asbestos, glass fiber/bead may also be encapsulated or dispersed in the composite in order to obtain desired mechanical properties. The percentage of the inorganic fillers/fibers may vary from 5% to 30% by weight of the composite composition. The percentage of the thermoplastic matrix in the composite composition may vary from 20% to 95% by weight of the mixture, preferably 30 to 95% and more preferably from 40% to 80% by weight.

### DETAILED DESCRIPTION

The composite in accordance with the invention generally comprises a continuous thermoplastic matrix phase and a discontinuous phase of cellulosic material. The discontinuous phase of cellulosic material may be in the form of relatively coarse components such as chips, flake or relatively large particles. Alternatively the invention includes composites in which the dispersed phase is in the form of fine discrete fibers or particles which are evenly dispersed within the matrix so that the dispersed phase is not readily visible to the naked eye. The dispersed phase may comprise structured particles in the form of sheets, plates, ribbons, woven or non-woven fabric portions. Alternatively the cellulosic dispersed phase may be a random dispersion of particles or fibers.

The cellulose reinforcing material may be in any suitable form. Examples of cellulosic reinforcement including but are not limited to, fiber, chip, flake, flour (sawdust, powder) etc. Wood reinforcements that may be present in the composites according to this invention may be derived from virgin wood fibers or waste wood byproducts. These include, but are not limited to, urban and demolition wood waste, wood trim pieces, wood milling by-products, pellets, paper pulp, sawdust, scrap paper/newspaper. Wood waste originated from plywood, particle board and MDF sawdust and CCA treated timber may also be used provided the emission of the toxic compounds during processing and under service conditions of the resultant wood/plastic composites is negligible. Other cellulose-based natural fibers that may be used, include but are not limited to, flax, bagass, jute, hemp, sisal, cotton, ramie, coir, straw and the like. The wood reinforcements may vary greatly in size, shape, particles size distribution, and aspect ratio including but not limited to chips, flours, flakes and fibers. The amount of wood or natural fiber components blended with the thermoplastic polymer may vary over a wide range depending upon the particular end-use application. This may vary from 5% to 80% by weight of the mixture, preferably 5 to 70% and more preferably from 20% to 60% by weight.

The coupling agent plays a crucial role in enhancing the ultimate wood/plastic composite performance by enabling intimate blending of the dissimilar surfaces of the wood/cellulose component which is hydrophilic and the thermoplastic polymer which is typically hydrophobic. Although not limited by theory, we believe that the coupling agent acts as a molecular bridge between the two main composite components.

The coupling agents effective in this invention would include organic compounds, oligomers or polymer compounds containing at least one reactive nitrogen groups such as but not limited to: amines, oxazolines, aziridenes, carbodiimides, imines, imides, amidines, amides, lactames, nitrites, azides, imidazoles, amino-acids, isonitriles and aromatic amines such as pyridines and indoles etc. The nitrogen may be protonated or present as a quaternary salt but most preferably will be in its ‘free base’ form. Where there are more than two nitrogen containing groups these may be of the same or different groups. It is preferred that the coupling agent is selected from compounds containing at least two reactive nitrogen groups and mixture of said compounds. These reactive nitrogen-containing compounds are capable of forming hydrogen bonding and/or chemical bonds with the hydroxyl groups of the wood/cellulose component. The coupling agent may be present in an amount of from 0.1% to 20% by weight of the composite mixture, preferably from 0.25% to 5% by weight.

The preferred coupling agents consist of carbon hydrogen and nitrogen and optionally oxygen sulphur or phosphorous. The coupling agents will generally not contain metals or metalloid elements such as zirconium, silicon or titanium.

The nitrogen containing coupling agents include low and/or high molecular weight organic/polymeric compounds having mono- or multifunctional amine groups. The amines can be primary, secondary, and/or tertiary amines, or a mixture of these three types of amines. However, primary and secondary amines are preferred due to their higher chemical reactivities in comparison with the tertiary amines based on steric consideration. Suitable examples of amine containing compounds include but are not limited to, polyethyleneimines, polyallylamines, polyvinylamine, amine-terminated acrylonitrile-butadiene-styrene, polyoxyalkylene amine, triethylene tetramine, diamino propane, diamino butane, diamino pentane, diamino hexane, diamino octane, diamino decane, diamino nonane, diamino dodecane, hexamethylene diamine, pentaethylene hexamine, triamino pyrimidine, hexamethylenetetraamine diimidazoles, amino pyridines, triazoles, dioxazolines, 1,2-diaminocyclohexane, cyclic amines such as triazacyclononane, and amine based dendrimers such as polyamidoamine.

Other suitable nitrogen containing compounds include, but are not limited to, 1-aziridineethanol, polyethyl oxazoline, oxazoline, aziridine or acrylamide/aminoacrylate modified polyethylene or polypropylene, and 1-ethyl-3-(3-dimethylaminopropyl)carbodiimide, dicyclohexylcarbodiimide.

The preferred coupling agent systems may vary dependent upon the cellulose-polymer composite combinations. For instance, the amine based coupling agents with or without the presence of a radical initiator (e.g. dicumyl peroxide) are preferred for cellulose-virgin or recycled polyolefin composites whilst the oxazoline based coupling agents with or without the presence of a radical initiator are preferred for cellulose-ABS composites.

The coupling agent system may contain one or more of the coupling agents described above with or without the presence of a suitable radical initiator. Suitable free radical generators include but not limited to those based on peroxide, peroxy ester and peroxy carbonate, hydroperoxide, azide, azido and azo containing compounds or combinations of the above. Suitable examples include but are not limited to dicumyl peroxide, lauroyl peroxide, azobisisbutyronitrile, bezoyl peroxide, tertiary butyl perbenzoate, di(tertiary-butyl)peroxide, cumene hydroperoxide, 2,5-dimethyl-2,5-di(t-butyl-peroxy) hexane, 2,5-dimethyl-2,5-di(t-butylperoxy) hexane, tertiary butyl hydroperoxide, isopropyl percarbonate, aminophenylsulfonylazide and the like. The dicumyl peroxide is particularly preferred. The radical initiators may be added in an amount of from 0.05% to 5% by weight of the matrix, either prior to fabrication of the wood/cellulose thermoplastic composite by prior blending of the radical initiator with the matrix or wood under suitable conditions or preferably by adding the free radical generator directly during the compounding or mixing stage of fabricating the wood/cellulose thermoplastic composite

The coupling agent system may be applied onto the wood component prior to the composite manufacturing process, or by pre-mixing it with the wood component or the matrix. Alternatively, the coupling agent system is added during the compounding or mixing stage of the composite. The coupling agent may be used as its normal form under ambient conditions, for example, as concentrated liquid or in solid form, or it may be applied from a diluted solution by dissolving the coupling agent in an appropriate solvent including water. The coupling agent system may also be applied through vapour phase deposition.

It is a particularly preferred embodiment of the present invention that the coupling agent system is added directly to the composite components during mixing and compounding stages. The coupling agent may be applied in its normal form under ambient conditions for example as concentrated liquid or in solid form, or it may be applied from a diluted solution by dissolving the coupling agent in an appropriate solvent including water. The treated cellulose reinforcement may then be dried prior to use for subsequent composite fabrication.

Apart from the coupling agents, other suitable additives such as antioxidants, UV-stablisers, pigments, dispersing agents and porosity/foaming agents may also be optionally added. The particular additives used will depend on the nature of the thermoplastic matrix and the desired properties. Examples of suitable antioxidants may include phenolics, aromatic amines and ketone-amine condensates, phosphites, sulfides, metal salts of dithioacids and mixtures thereof. Examples of UV-stablisers include 2-hydroxybenzophenones, benzotriazoles, bis-benzotriazoles, hindered-amine light stabilisers (HALS) and mixtures thereof. Suitable dispersing agents may consist of fatty acids, polyvinyl alcohols, wax, silicon-based or quaternary/phosphonium based surfactants, etc. Suitable porosity agents include but not limited to the group of paraffin or hydrocarbon wax blend having a melting point of 200° C. or lower. The additives may be added in an amount of from 0.05% to 5% by weight.

The claimed inventions improve chemical compatibility and increases interfacial interactions between the wood reinforcements and the thermoplastic matrix resin, resulting in significantly enhanced composite performance over known arrangements.

The wood/plastic composites of the invention may be manufactured by various conventional plastic processing technologies known in the art. These may include but are not limited to extrusion, injection moulding, or compression moulding process dependent upon the shape and size of the reinforcement, and availability of the processing equipment.

The combination of a thermoplastic with a cellulose-based reinforcement has been found to result in a wood plastic composite exhibiting advantages such as ease of production, improved water resistance, lower density, and negligible emission of toxic VOCs compared with existing wood/cellulose thermoset composites. Composite of wood/cellulose dispersed in a thermoplastic matrix also have a favorable price/performance ratio owing to the use of comparatively inexpensive renewable raw materials that are readily recyclable and that can be burned without leaving a residue. The composites manufactured according to the preferred embodiments of the present invention may also be recycled according to the methods disclosed herein to form “secondary products”, so that the raw materials can be reused many times to form useful products.

The invention further provides a process for manufacture of a composite comprising a thermoplastic matrix and cellulosic reinforcement, the process comprising: mixing, heating and forming a composition comprising the thermoplastic matrix and cellulosic reinforcing agent in the presence of the coupling agent with or without a radical initiator. Additives such as carbonates. UV-stabilizers, pigments, dispersion agents, foaming agent or the like or mixtures thereof may optionally be added.

The process inventions may include shaping the composite by extrusion. For example the product may be extruded through a suitable moulding die to provide a desired structural profile. Alternatively, or in addition, the composition may be foamed.

The cellulose reinforced thermoplastic composites developed according to this invention may be used but not limited to the manufacture of the following products:
Building and construction materials: roof systems (roof shingles, roof tiles, shakes), interior wall panels, light sheathing, insulating/acoustic panels, partitions, siding panels, flooring panels, decking panels, window and door frames, temporary housing structures, plastic lumber for applications such as docks, fence posts, decorative lawn or flower bed edging, and garden timber.
Highway construction products: sign posts, guide rail posts, sign blanks, fence posts, guide rail offset blocks, delineator posts, survey stakes, and landscape timber
Packaging products: shipping crates/containers, pallets, intermediate bulk containers, slip sheets for protection of surface, food packaging (food service trays, egg cartons), folding bins, folding display packages, perishable product crates, beverage trays
Automotive components: seat-back covers, rear interior panels, roof and door upholstery, dashboards, noise screens, under hoods, arm rests, lower noise screens, door linings, sunray deflectors, linings, covers on electric wire, back covers, automotive stillages (component bins)
Agricultural products: plastic soil stabilisation grids
Leisure products: outdoor furniture (benches, picnic tables), recreational boats, children's chairs and tables.
Others: storage bins, toys and games, plastic coat hangers, dollies, roll cages and cable drums.

The inventions will now be demonstrated by, but are not limited to, the following examples.

The wood (or cellulose)/polymer composites in the examples were produced by compression moulding at 180° C. with the mixtures of wood component either untreated or treated/mixed with the coupling agent and the polymer flake. Alternatively, the coupling agents and/or additives can be added into the wood and polymer components prior to processing. Six individual specimens (236 mm in length, 30 mm in width, and 7.5 mm in thickness) were cut from each compression-moulded composite board for subsequent testing. 3-point bending test was carried out according to ASTM D 790-97 with the following parameters: support span to depth ratio of 16:1, support span of 120 mm, loading nose radius of 12.5 mm, and a crosshead speed of 3.2 mm/min.

In the following example amounts are in parts by weight unless otherwise specified.

### EXAMPLE 1

This example describes the effect of different types of amine containing coupling agents on the mechanical performance of hardwood chip (50 parts)/recycled LDPE (50 parts) composites. The flexural strength and flexural modulus of these composites as determined by 3-point bending test are given in Table 1.

TABLE 1
Flexural strength and flexural modulus of hardwood (50 parts)/recycled
LDPE (50 parts) composites with and without addition of an
amine-containing coupling agent

| | Flexural | Flexural |
|---|---|---|
| | Strength | Modulus |
| Composite Composition | (MPa) | (MPa) |
| 50 parts hardwood/50 parts recycled LDPE | 21 | 1600 |
| 50 parts hardwood/50 parts recycled LDPE + 5 | 24 | 1680 |
| parts amine-terminated acrylonitrile- | | |
| butadiene-styrene (ATBN) | | |
| 50 parts hardwood/50 parts recycled LDPE + 5 | 33 | 2400 |
| parts Polyethylene imine (PEI) | | |
| (Mw = 25,000) | | |

The results in Table 1 indicate that the application of an amine-containing coupling agent leads to significant improvements of the composite performance. The polyethylene imine (PEI) compound is much more effective than the ATBN in terms of enhancing the composite performance possibly due to larger number of reactive amino groups available on the PEI molecule for exchanging interactions with both the wood and the LDPE matrix.

### EXAMPLE 2

This example compare the effect of PEI with an isocyanate compound (PMPPIC) described in prior arts on the mechanical performance of hardwood chip (50 parts)/recycled LDPE (50 parts) composites. The flexural strength and flexural modulus of these composites as determined by 3-point bending test are given in Table 2.

TABLE 2
Flexural strength and flexural modulus of hardwood chip (50 parts)/
recycled LDPE (50 parts) composites with addition of PEI (750k)
or an isocyanate compound (PMPPIC) as known in the literature

| | Flexural | Flexural |
|---|---|---|
| | Strength | Modulus |
| Composite Composition | (MPa) | (MPa) |
| 50 parts hardwood/50 parts recycled LDPE | 21 | 1600 |
| 50 parts hardwood/50 parts recycled LDPE + 2 | 30 | 2100 |
| parts Polyethylene imine (PEI) | | |
| (Mw = 750,000) | | |
| 50 parts hardwood/50 parts recycled LDPE + 2 | 26 | 1820 |
| parts Polymethylene polyphenyl | | |
| isocyanate (PMPPIC) | | |

Under similar experimental conditions, the PEI is shown to be more effective than the PMPPIC in enhancing the flexural performance of the hardwood/recycled LDPE composite.

### EXAMPLE 3

This example describes the effect of different types of active nitrogen containing coupling agents on the mechanical performance of softwood chip (50 parts pine radiata)/recycled LDPE (50 parts) composites. The flexural strength and flexural modulus of these composites as determined by 3-point bending test are given in Table 3.

TABLE 3
Flexural strength and flexural modulus of softwood chip (50 parts pine
radiata)/recycled LDPE (50 parts) composites with and without addition
of an active nitrogen-containing coupling agent

| | Flexural | Flexural |
|---|---|---|
| | Strength | Modulus |
| Composite Composition | (MPa) | (MPa) |
| 50 parts softwood/50 parts recycled LDPE | 16 | 1230 |
| 50 parts softwood/50 parts recycled LDPE + 5 | 23 | 1900 |
| parts Polyethylene imine (PEI) (Mw = 25,000) | | |
| 50 parts softwood/50 parts recycled LDPE + 5 | 19 | 1590 |
| parts triethylene tetramine | | |
| 50 parts softwood/50 parts recycled LDPE + 5 | 18 | 1500 |
| parts Diamino Hexane | | |
| 50 parts softwood/50 parts recycled LDPE + 5 | 19 | 1500 |
| parts Polyethyl Oxazoline | | |

It appears that the amine-containing polymer (PEI 25k) is a more effective coupling agent as compared to the small amino compounds and the polyethyl oxazoline investigated for this composite formulation.

### EXAMPLE 4

The example shows the influence of molecular weight of polyethylene imine molecules on the mechanical performance of hardwood chip (50 parts)/recycled LDPE (50 parts) composites. The flexural strength and flexural modulus of these composites as determined by 3-point bending test are given in Table 4.

TABLE 4
Flexural strength and flexural modulus of hardwood (50 parts)/recycled
LDPE (50 parts) composites with polyethyleneimines (PEI) of different
molecular weights

| | Flexural | |
|---|---|---|
| | Strength | Flexural Modulus |
| Composite Composition | (MPa) | (MPa) |
| 50 parts hardwood/50 parts recycled LDPE | 21 | 1600 |
| 50 parts hardwood/50 parts recycled | 29 | 2200 |
| LDPE + 2 parts Polyethylene imine | | |
| (Mw = 2,000) | | |
| 50 parts hardwood/50 parts recycled | 27 | 2000 |
| LDPE + 2 parts Polyethylene imine | | |
| (Mw = 25,000) | | |
| 50 parts hardwood/50 parts recycled | 30 | 2100 |
| LDPE + 2 parts Polyethylene imine | | |
| (Mw = 750,000) | | |
| 50 parts hardwood/50 parts recycled | 29 | 2000 |
| LDPE + 2 parts Polyethylene imine | | |
| (Mw = 2,000,000) | | |

It is clear from the results in Table 3 that the addition of the PEI coupling agent into the hardwood/plastic mixture results in significant increases of flexural strength and flexural modulus of the final composite products. However, the extent of composite performance improvement does not seem to be sensitive to the chain lengths of the PEI coupling molecules within the range of molecular weights investigated (e.g. from 2,000 to 2,000,000).

### EXAMPLE 5

This example investigates the influence of polyethylene imine concentrations on the mechanical performance of hardwood chip (50 parts)/recycled LDPE (50 parts) composites. The flexural strength and flexural modulus of these composites as determined by 3-point bending test are given in Table 5.

TABLE 5
Flexural strength and flexural modulus of hardwood (50 parts)/recycled
LDPE (50 parts) composites with polyethyleneimines (PEI) of different
concentrations

| | Flexural | |
|---|---|---|
| | Strength | Flexural Modulus |
| Composite Composition | (MPa) | (MPa) |
| 50 parts hardwood/50 parts recycled | 21 | 1600 |
| LDPE | | |
| 50 parts hardwood/50 parts recycled | 27 | 2000 |
| LDPE + 2 parts Polyethylene imine | | |
| (Mw = 25,000) | | |
| 50 parts hardwood/50 parts recycled | 33 | 2400 |
| LDPE + 5 parts Polyethylene imine | | |
| (Mw = 25,000) | | |

The results in Table 5 indicate that the addition of 5 parts PEI results in further improvements of the mechanical properties of the composites as compared to the addition of 2 parts PEI. Therefore, the concentration of the coupling agent appears to significantly affect the composite performance.

### EXAMPLE 6

This example investigates the influence of polyethylene imine concentrations on the mechanical performance of softwood chip (50 parts pine radiata)/recycled LDPE (50 parts) composites. The flexural strength and flexural modulus of these composites as determined by 3-point bending test are given in Table 6.

TABLE 6
Flexural strength and flexural modulus of softwood (50 parts)/recycled
LDPE (50 parts) composites with polyethyleneimines (PEI) of different
concentrations

| | Flexural Strength | Flexural |
|---|---|---|
| Composite Composition | (MPa) | Modulus (MPa) |
| 50 parts softwood/50 parts recycled | 16 | 1220 |
| LDPE | | |
| 50 parts softwood/50 parts recycled | 18 | 1300 |
| LDPE + 0.25 parts Polyethylene | | |
| imine (Mw = 25,000) | | |
| 50 parts softwood/50 parts recycled | 16 | 1300 |
| LDPE + 0.5 parts Polyethylene | | |
| imine (Mw = 25,000) | | |
| 50 parts softwood/50 parts recycled | 18 | 1400 |
| LDPE + 1 parts Polyethylene imine | | |
| (Mw = 25,000) | | |
| 50 parts softwood/50 parts recycled | 16 | 1290 |
| LDPE + 2 parts Polyethylene imine | | |
| (Mw = 25,000) | | |
| 50 parts softwood/50 parts recycled | 21 | 1580 |
| LDPE + 3 parts Polyethylene imine | | |
| (Mw = 25,000) | | |
| 50 parts softwood/50 parts recycled | 22 | 1600 |
| LDPE + 4 parts Polyethylene imine | | |
| (Mw = 25,000) | | |
| 50 parts softwood/50 parts recycled | 23 | 1900 |
| LDPE + 5 parts Polyethylene imine | | |
| (Mw = 25,000) | | |
| 50 parts softwood/50 parts recycled | 21 | 1700 |
| LDPE + 8 parts Polyethylene imine | | |
| (Mw = 25,000) | | |

The results seem to indicate that 5 parts PEI (25k) lead to optimum performance for the composite system investigated.

### EXAMPLE 7

This example compares the effect of using PEI (25k) as the coupling molecule with those of employing other conventional types of coupling agents on the mechanical performance of softwood chip (50 parts pine radiata)/recycled LDPE (50 parts) composites. The flexural strength and flexural modulus of these composites as determined by 3-point bending test are given in Table 7.

TABLE 7
Flexural strength and flexural modulus of softwood (50 parts)/
recycled LDPE (50 parts) composites with either PEI (25k) or
other conventional coupling agents

| | Flexural Strength | Flexural |
|---|---|---|
| Composite Composition | (MPa) | Modulus (MPa) |
| 50 parts softwood/50 parts recycled | 16 | 1220 |
| LDPE | | |
| 50 parts softwood/50 parts recycled | 21 | 1700 |
| LDPE + 8 parts Polyethylene imine | | |
| (Mw = 25,000) | | |
| 50 parts softwood/50 parts recycled | 16 | 1240 |
| LDPE + 8 parts Amino Zirconate | | |
| (Teaz) | | |
| 50 parts softwood/50 parts recycled | 19 | 1400 |
| LDPE + 8 parts Amino Silane (Z- | | |
| 6026) | | |

The results show that the PEI (25k) molecules are more effective than the organometallic coupling agents for improving the WPC performance.

### EXAMPLE 8

This example investigates the addition of an amino compound and a radical initiator on the mechanical performance of softwood chip (50 parts pine radiata)/recycled LDPE (50 parts) composites. The flexural strength and flexural modulus of these composites as determined by 3-point bending test are given in Table 8.

TABLE 8
Flexural strength and flexural modulus of softwood (50 parts)/
recycled LDPE (50 parts) composites with an amino compound
together with a radical initiator

| | Flexural Strength | Flexural |
|---|---|---|
| Composite Composition | (MPa) | Modulus (MPa) |
| 50 parts softwood/50 parts recycled | 16 | 1200 |
| LDPE | | |
| 50 parts softwood/50 parts recycled | 28 | 1700 |
| LDPE + 2 parts Polyethylene imine | | |
| (Mw = 25,000) + 0.5 parts Dicumyl | | |
| Peroxide | | |
| 50 parts softwood/50 parts recycled | 28 | 1900 |
| LDPE + 5 parts Polyethylene imine | | |
| (Mw = 25,000) + 0.5 parts Dicumyl | | |
| Peroxide | | |
| 50 parts softwood/50 parts recycled | 18 | 1500 |
| LDPE + 5 parts Polyethylene imine | | |
| (Mw = 25,000) + 0.5 parts Hydrogen | | |
| Peroxide | | |
| 50 parts softwood/50 parts recycled | 28 | 2100 |
| LDPE + 5 parts Diamino Hexane | | |
| (Mw = 25,000) + 0.5 parts Dicumyl | | |
| Peroxide | | |

The results indicate that the addition of the dicumyl peroxide together with the amino compound is beneficial for enhancement of the wood/LDPE composite performance.

### EXAMPLE 9

This example investigates the addition of an active nitrogen containing compound on the mechanical performance of softwood chip (50 parts pine radiata)/recycled HDPE (50 parts) composites. The flexural strength and flexural modulus of these composites as determined by 3-point bending test are given in Table 9.

TABLE 9
Flexural strength and flexural modulus of softwood (50 parts)/
recycled HDPE (50 parts) composites with the addition of an
active nitrogen containing compound

| | Flexural Strength | Flexural |
|---|---|---|
| Composite Composition | (MPa) | Modulus (MPa) |
| 50 parts softwood/50 parts recycled | 30 | 2500 |
| HDPE | | |
| 50 parts softwood/50 parts recycled | 42 | 2900 |
| HDPE + 5 parts Polyethylene imine | | |
| (PEI) (Mw = 25,000) | | |
| 50 parts softwood/50 parts recycled | 34 | 3000 |
| HDPE + 5 parts Polyethyl Oxazoline | | |
| (PEO) (Mw = 50,000) | | |

The results indicate that both PEI and PEO are able to improve the wood/HDPE composite performance although the effect of PEI is more significant.

### EXAMPLE 10

This example investigates the addition of PEI (25k) on the mechanical performance of softwood chip (50 parts pine radiata)/recycled PP (50 parts) composites. The flexural strength and flexural modulus of these composites as determined by 3-point bending test are given in Table 10.

TABLE 10
Flexural strength and flexural modulus of softwood (50 parts)/
recycled PP (50 parts) composites with the addition of PEI (25k)

| | Flexural Strength | Flexural |
|---|---|---|
| Composite Composition | (MPa) | Modulus (MPa) |
| 50 parts softwood/50 parts recycled | 22 | 1900 |
| PP | | |
| 50 parts softwood/50 parts recycled | 32 | 2600 |
| PP + 5.55 parts Polyethylene imine | | |
| (Mw = 25,000) | | |

The results show that the addition of the PEI (25k) improves the performance of the wood/PP composite.

### EXAMPLE 11

This example investigates the addition of PEI (25k) on the mechanical performance of softwood chip (50 parts pine radiata)/recycled HIPS (50 parts) composites. The flexural strength and flexural modulus of these composites as determined by 3-point bending test are given in Table 11.

TABLE 11
Flexural strength and flexural modulus of softwood (50 parts/recycled
HIPS (50 parts) composites with the addition of PEI (25 k)

| | Flexural Strength | Flexural Modulus |
|---|---|---|
| Composite Composition | (MPa) | (MPa) |
| 50 parts softwood/50 parts recycled | 29 | 2800 |
| HIPS | | |
| 50 parts softwood/50 parts recycled | 32 | 3000 |
| HIPS + 5 parts Polyethylene imine | | |
| (Mw = 25,000) | | |

The results show that the addition of the PEI (25k) slightly improves the performance of the wood/HIPS composite. However, more significant improvement of the performance may be achieved by using other coupling molecules or their combinations within the scope of this invention.

### EXAMPLE 12

This example investigates the addition of the addition of an active nitrogen containing coupling molecule on the mechanical performance of softwood chip (50 parts pine radiata)/recycled ABS (50 parts) composites. The flexural strength and flexural modulus of these composites as determined by 3-point bending test are given in Table 12.

TABLE 12
Flexural strength and flexural modulus of softwood
(50 parts)/recycled ABS (50 parts) composites with
the addition of an active nitrogen containing coupling molecule

| | Flexural Strength | Flexural Modulus |
|---|---|---|
| Composite Composition | (MPa) | (MPa) |
| 50 parts softwood/50 parts recycled | 38 | 3500 |
| ABS | | |
| 50 parts softwood/50 parts recycled | 49 | 4400 |
| ABS + 5 parts Polyethylene imine | | |
| (Mw = 25,000) | | |
| 50 parts softwood/50 parts recycled | 55 | 5100 |
| ABS + 5 parts Polyethyl Ozaxoline | | |
| (Mw = 200,000) | | |
| 50 parts softwood/50 parts recycled | 56 | 5100 |
| ABS + 5 parts Polyethyl Ozaxoline | | |
| (Mw = 50,000) | | |
| 50 parts softwood/50 parts recycled | 41 | 3900 |
| ABS + 5 parts Ethyl Ozaxoline | | |

The results show that all of the active nitrogen containing molecules used improves the flexural properties of the wood/ABS composites although the polyethyl Ozaxoline molecules seem to be the most effective compound regardless of its molecular weight.

### EXAMPLE 13

This example compares the effect of polyethyl Oxazoline (PEO) with an isocyanate compound (PMPPIC) described in the literature on the mechanical performance of softwood chip (50 parts pine radiata)/recycled ABS (50 parts) composites. The flexural strength and flexural modulus of these composites as determined by 3-point bending test are given in Table 13.

TABLE 13
Flexural strength and flexural modulus of softwood chip
(50 parts)/recycled ABS (50 parts) composites with addition of
PEO (200 k) or an isocyanate compound (PMPPIC) as known in literature

| | Flexural Strength | Flexural Modulus |
|---|---|---|
| Composite Composition | (MPa) | (MPa) |
| 50 parts softwood/50 parts | 38 | 3500 |
| recycled ABS | | |
| 50 parts softwood/50 parts recycled | 55 | 5100 |
| ABS + 5 parts PEO | | |
| (Mw = 200,000) | | |
| 50 parts softwood/50 parts recycled | 39 | 3800 |
| ABS + 5 parts Polymethylene | | |
| polyphenyl isocyanate (PMPPIC) | | |

Under similar experimental conditions, the PEO is much more effective than the PMPPIC in enhancing the flexural performance of the hardwood/recycled ABS composite.

### EXAMPLE 14

This example investigates the addition of PEI (25k) on the mechanical performance of Bagass fiber (50 parts)/recycled LDPE (50 parts) composites. The flexural strength and flexural modulus of these composites as determined by 3-point bending test are given in Table 14.

TABLE 14
Flexural strength and flexural modulus of Bagass fiber/recycled
LDPE composites with the addition of PEI (25 k)

| | Flexural Strength | Flexural Modulus |
|---|---|---|
| Composite Composition | (MPa) | (MPa) |
| 50 parts Bagss/50 parts recycled | 20 | 1180 |
| LDPE | | |
| 50 parts Bagss/50 parts recycled | 24 | 1700 |
| LDPE + 5 parts PEI | | |
| (Mw = 25,000) | | |

The results show that PEI was able to improve the flexural properties of the Bagass/recycled LDPE composites.

1. A composite comprising a thermoplastic matrix, a cellulosic reinforcement phase and a coupling agent for improving the interaction between the thermoplastic matrix and cellulosic phase where the coupling agent is selected from compounds comprising one or more reactive nitrogen groups.

2. A composite according to claim 1 comprising:
(a) 20 to 95% by weight of the composite of the thermoplastic matrix;
(b) 5 to 80% by weight of the cellulosic phase; and
(c) 0.1 to 20% by weight of the coupling agent.

3. A composite comprising:
(a) from 40 to 80% by weight of the composite of a thermoplastic matrix;
(b) from 20 to 60% by weight of the composite of a cellulosic phase; and
(c) from 0.25 to 20% by weight of a coupling agent selected from the group consisting of compounds comprising mono- or multifunctional reactive nitrogen groups.

4. A composite according to claim 1 wherein the thermoplastic forms a continuous matrix phase and the cellulosic phase is discontinuous.

5. A composite according to claim 1 wherein the coupling agent is selected from organic compounds, oligomers or polymer compounds containing one or more reactive nitrogen groups independently selected from the group consisting of amines, oxazolines, aziridenes, carbodiimides, imines, imides, amidines, amides, lactames, nitrites, azides, imidazoles, amino-acids, isonitriles and aromatic amines such as pyridines and indoles.

6. A composite according to claim 4 wherein the coupling agent comprises one or more compounds selected from the group consisting of: polyethyleneimines, polyamidoamine, polyallylamines, polyvinylamine, amine-terminated acrylonitrile-butadiene-styrene, polyoxyalkylene amine, triethylene tetramine, diamino propane, diamino butane, diamino pentane, diamino hexane, diamino octane, diamino decane, diamino nonane, diamino dodecane, hexamethylene diamine, pentaethylene hexamine, triamino pyrimidine, hexamethylenetetraamine diimidazoles, amino pyridines, triazoles, dioxazolines, 1,2-diaminocyclohexane; and cyclic amines such as triazacyclononane, and amine based dendrimers 1-aziridineethanol, polyethyl oxazoline, oxazoline, aziridine or acrylamide/aminoacrylate modified polyethylene or polypropylene, and 1-ethyl-3-(3-dimethylaminopropyl)carbodiimide and dicyclohexylcarbodi-imide.

7. A composite according to claim 5 wherein the coupling agent comprises at least two said reactive nitrogen groups.

8. A composite according to claim 1 wherein the coupling agent is selected from polyethyleneimine of molecular weight in the range of from 500 to 2,000,000 and polyethyloxazoline of molecular weight in the range of from 500 to 2,000,000.

9. A composite according to claim 1 wherein the thermoplastic is selected from the group consisting of polyolifins, polyvinyl chloride, polystyrene, HIPS, ABS, PET, nylon and mixtures thereof.

10. A composite according to claim 9 wherein the thermoplastic matrix consists essentially of a polymer composition containing at least 90% of monomer units derived from C₂ to C₆ olefins.

11. A composite according to claim 1 wherein the cellulosic reinforcement is selected from the group consisting of particles and fibers of one or more sources of cellulosic material selected from hardwood, softwood, plywood, chipboard (particle board, MDF, etc), CCA treated timber, flax, jute, bagass, hemp, sisal, cotton, ramie, soir and straw.

12. A composite according to claim 1 wherein the composition further includes a free radical initiator.

13. A composite according to claim 12 wherein the free radical generator is selected from peroxide, peroxy ester and peroxy carbonate, hydroperoxide, azide, azido and azo containing compounds and mixtures thereof.

14. A composite according to claim 11 wherein the radical initiator is selected from the group consisting of dicumyl peroxide, lauroyl peroxide, azobisisbutyronitrile, bezoyl peroxide, tertiary butyl perbenzoate, di(tertiary-butyl)peroxide, cumene hydroperoxide, 2,5-dimethyl-2,5-di(t-butyl-peroxy) hexane, 2,5-dimethyl-2,5-di(t-butylperoxy) hexane, tertiary butyl hydroperoxide, isopropyl percarbonate, aminophenylsulfonylazide and mixtures thereof.

15. A composite according to claim 12 wherein the free radical initiator is dicumyl peroxide.

16. A composite according to claim 1 further comprising one or more additives selected from the group consisting of stabilizers, lubricants, antioxidants, impact modifiers, pigments, foaming agents, fire retardants, dispersing agents, porosity agents and inorganic fillers/fibers.

17. A process for preparing a composite comprising a thermoplastic matrix and cellulosic reinforcement, the process comprising mixing, heating and forming the composition to produce a mixture of a continuous phase comprising a thermoplastic and a discontinuous phase of cellulosic reinforcement in the presence of a coupling agent selected from compounds comprising one or more reactive nitrogen groups optionally in the presence of one or more of a radical initiator and other suitable additives.
